(19) United States
(12) Patent Application Publication
(10) Pub. No.: US 2010/0277437 A1
(43) Pub. Date: Nov. 4, 2010

(54) ELECTRONIC DEVICE AND CONTROLLING METHOD THEREOF

(75) Inventor: Wen Shu, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (TW); HON HAI PRECISION INDUSTRY CO., LTD., Tu Cheng (TW)

(21) Appl. No.: 12/641,337

(22) Filed: Dec. 18, 2009

(30) Foreign Application Priority Data
Apr. 30, 2009 (CN) 200910302044.9

(51) Int. Cl. G06F 3/042

(52) U.S. Cl. 345/175

(57) ABSTRACT

An electronic device includes a touch-screen, an infrared emitter, an infrared sensor and a control module. The touch-screen is configured for displaying a interface with various touchable items. The infrared emitter is configured for emitting infrared light. The infrared sensor is configured for receiving reflected infrared light, and for generating an electrical signal according to the reflected infrared light. The control module is configured for receiving the electrical signal and determining whether the value of the electrical signal is higher than a standard value. If the value of the electrical signal is higher than the standard value, the control module is further configured for invoking the touch interface on the touch-screen.

### BACKGROUND

1. Technical Field

The present disclosure relates to electronic devices, and, more particularly, to an electronic device with automatically invoking a interface.

2. Description of Related Art

As the cost and complexity decreases, more and more current electronic devices are using touch-screens as input units. To interact with a touch-screen of an electronic device, such as computers set in a public place, the user must physically touch the touch interface of the touch-screen or by pressing keys. Thus, the user must perform additional action before being presented with a menu choice.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of an electronic device in accordance with an exemplary embodiment.

FIG. 2 is a functional block diagram of the electronic device of FIG. 1.

FIG. 3 is a flowchart of a controlling method for automatically controlling an electronic device in accordance with an exemplary embodiment.

### DETAILED DESCRIPTION

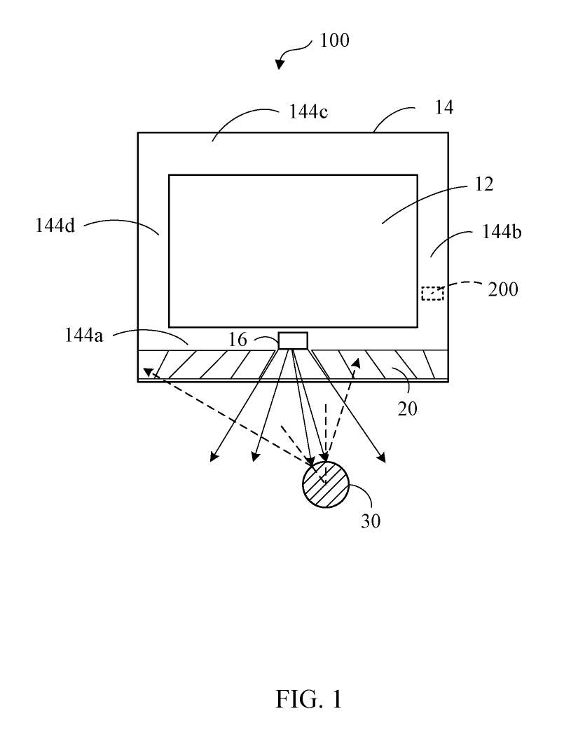

Referring to FIG. 1, a schematic view of an electronic device 100 is shown according to an exemplary embodiment. The electronic device 100 includes a touch-screen 12, a front frame 14, an infrared emitter 16, an infrared sensor 20, and a control module 200. A block object 30 is at the front of the electronic device 100.

The touch-screen 12 is configured for displaying information according to touch operation. In this embodiment, the touch-screen 12 displays a touch interface with various touchable items. The touch-screen 12 can be a resistive touch screen and a capacitive touch screen.

The front frame 14 is configured for receiving the touch-screen 12. The front frame 14 includes four panes 144a, 144b, 144c, 144d. The four panes 144a, 144b, 144c, 144d interconnect with each other to define the front frame 14. The pane 144a is on the lower one of the front frame 14.

The infrared emitter 16 is set in the front frame 14, and configured for emitting infrared light. In this embodiment, the infrared emitter 16 is set in the center of the pane 144a, and the infrared emitter 16 emits infrared light in a 150 degree angle. In other embodiment, the infrared emitter 16 maybe a laser emitter. Infrared light emitted from the infrared emitter 16 impinges on the block object 30, and is reflected by the block object 30. Understandably, the shorter the distance between the block object 30 and the infrared emitter 16, the more reflect infrared light is reflected by the block object 30.

The infrared sensor 20 is configured for receiving reflected infrared light reflected by the block object 30, and generating an electrical signal (current or voltage). In this embodiment, the electrical signal is current. The infrared sensor 20 is set in the front frame 14. In this embodiment, the infrared sensor 20 is set in the pane 144a, and next to the infrared emitter 16. The infrared sensor 20 can be a photoconductor. The photoconductor is configured for receiving the reflected infrared light and generating current according to the reflected infrared light.

The control module 200 is set inside of the front frame 14. The control module 200 is configured for receiving the current, and determining whether the current value is higher than a standard value stored in the control module 200. If the current value is higher than the standard value, a distance between the object 30 and the touch-screen 12 is within a predetermined value, and the control module 200 is further configured for invoking the touch interface on the touch-screen 12. If the current value is lower than the standard value, the control module 200 is configured for disabling the touch-screen 12. The standard value can be defined according to a distance between the electronic device 100 and the block object 30. The control module 200 is further configured for executing different functions of the electronic device 100 according to the touch operation from the touch-screen 12.

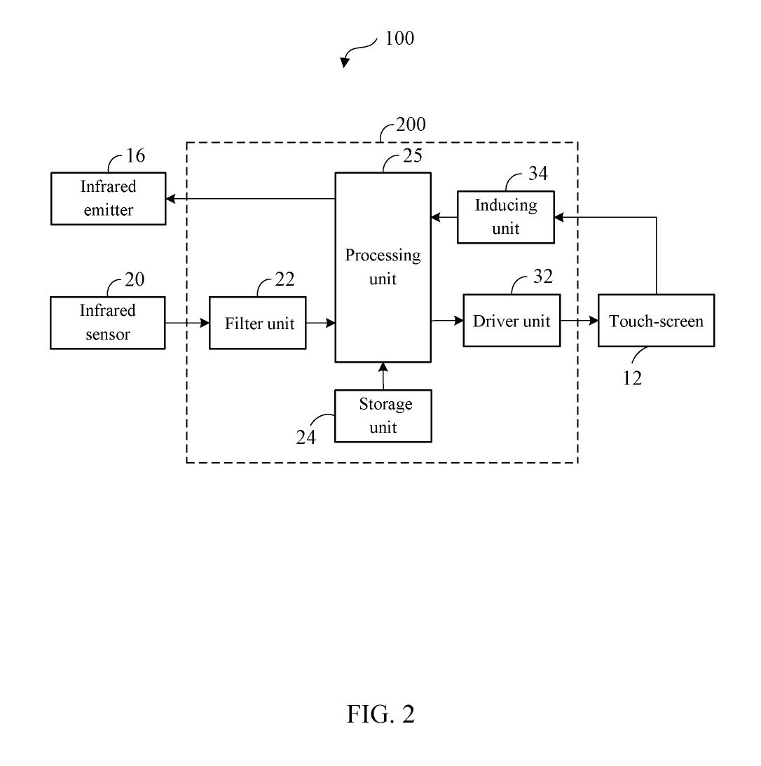

Referring to FIG. 2, the control module 200 includes a filter unit 22, a storage unit 24, a processing unit 25, a driver unit 32, and an inducing unit 34. The processing unit 25 electrically connects the filter unit 22, the storage unit 24, the driver unit 32, and the inducing unit 34.

The filter unit 22 is configured for filtering the current of the infrared sensor 20 and transferring filtered current to the processing unit 25. The storage unit 24 is configured for storing the standard value. In one embodiment, the storage unit 24 can be integrated in the processing unit 25. The inducing unit 34 is configured for transforming the touch operation from the touch interface into operating instructions. The inducing unit 34 determines the pressure applied by the touch operation, amplifying the touching signals, transferring analog signals to digital signals, and so on.

The processing unit 25 is configured for providing pulse signals to activate or deactivate the infrared emitter 16, thus, saving power. The frequency of the pulse signals can be 38 k hertz (HZ). The processing unit 25 is further configured for receiving a filtered current value of the filtered current, and determining whether the filtered current value is higher than the standard value. When the filtered current value is higher than the standard value, the processing unit 25 is further configured for generating a first drive signal. When the filtered current value is lower than the standard value, the processing unit 25 is further configured for generating a second drive signal. The processing unit 25 is further configured for executing different functions of the electronic device 100 according to the operating instructions of the inducing unit 34.

The driver unit 32 is configured for driving the touch-screen 12 to activate or deactivate the touch interface, according to the first drive signal or the second drive signal.

When the object 30 such as a user is in front of the electronic device 100, the infrared sensor 20 receives the reflected infrared light reflected by the block object 30, and transforms the reflected infrared light into a current value accordingly. When the control module 200 determines that the current value is higher than the standard value, the control module 200 activates/invokes the touch interface on the touch-screen 12. Thus, the electronic device 100 automatically invokes the touch interface.

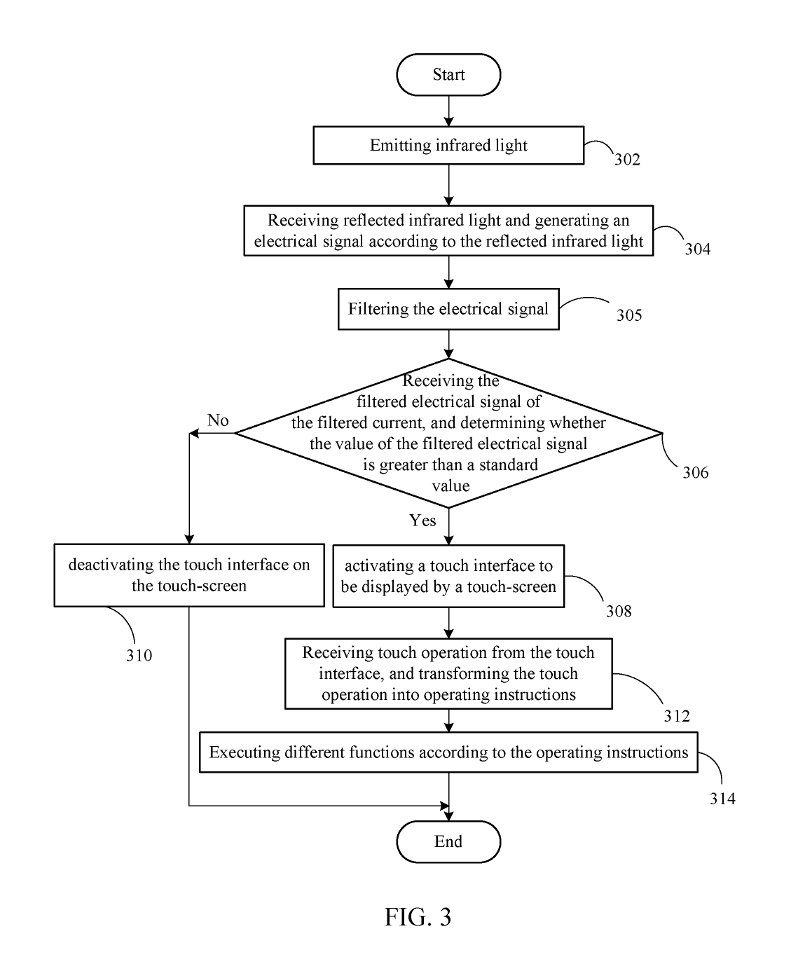

Further referring to FIG. 3, a flowchart of a controlling method for the electronic device 100 in accordance with an exemplary embodiment is shown. The controlling method shown includes the following steps.

In step S302, emitting infrared light. This step is performed by the infrared emitter 16.

In step S304, receiving reflected infrared light, and generating an electrical signal according to the reflected infrared light.

In step S305, filtering the current.

In step S306, receiving the filtered current, and determining whether the filtered current value is higher than a standard value. If the filtered current value is higher than the standard value, step S308 is implemented. If the filtered current value is lower than the standard value, step S310 is implemented. The standard value is stored in the storage unit 24.

In step S308, enabling a touch interface to be displayed by a touch-screen.

In step S310, disabling the touch interface to be displayed by the touch-screen.

In step S312, receiving touch operation from the touch interface, and transforming the touch operation into operating instructions.

In step S314, executing different functions according to the operating instructions.

It is to be understood, however, that even though numerous has been described with reference to particular embodiments, but the present invention is not limited to the particular embodiments described and exemplified, and the embodiments are capable of considerable variation and modification without departure from the scope of the appended claims.

What is claimed is:

1. An electronic device, comprising:
a touch-screen configured for displaying a interface with various touchable items;
an infrared emitter configured for emitting infrared light;
an infrared sensor configured for receiving reflected infrared light, and for generating an electrical signal according to the reflected infrared light; and
a control module configured for receiving the electrical signal and determining whether the value of the electrical signal is higher than a standard value, if the value of the electrical signal is higher than the standard value, the control module further configured for invoking the touch interface on the touch-screen.

2. The electronic device of claim 1, further comprising a front frame configured for receiving the touch-screen.

3. The electronic device of claim 2, wherein the front frame comprises four panes, the four panes interconnect with each other, and the infrared emitter is set in one of the four panes, the infrared sensor is arranged next to the infrared emitter.

4. The electronic device of claim 2, wherein the control module is embodied in the front frame.

5. The electronic device of claim 1, wherein the control module comprises:
a storage unit configured for storing the standard value;
a filter unit configured for filtering the electrical signal of the infrared sensor, and;
a processing unit configured for receiving a the filtered electrical signal and determining whether the value of the filtered electrical signal is higher than the standard value, if the value of the filtered electrical signal is higher than the standard value, the processing unit generating a first drive signal, if the value of the filtered electrical signal is lower than the standard value, the processing unit generating a second drive signal; and
a driver unit configured for invoking the interface on the touch-screen according to the first drive signal, or deactivating the interface on the touch-screen according to the second drive signal.

6. The electronic device of claim 5, wherein the control module further comprises an inducing unit, the inducing unit is configured for transforming touch operations from the interface into operating instructions; and the processing unit is further configured for executing different functions of the electronic device according to the operating instructions.

7. The electronic device of claim 5, wherein the storage unit is integrated in the processing unit.

8. The electronic device of claim 5, wherein the processing unit is further configured for providing pulse signals to activate or deactivate the infrared emitter.

9. The electronic device of claim 1, wherein the infrared sensor comprises a photoconductor.

10. The electronic device of claim 1, further comprising a storage unit configured for storing the standard value.

11. The electronic device of claim 1, further comprising a filter unit configured for filtering the electrical signal of the infrared sensor.

12. The electronic device of claim 1, wherein the electrical signal is a selection from current and voltage.

13. A controlling method for controlling an electronic device, the electronic device comprising a touch-screen for displaying a interface, the controlling method comprising:
emitting infrared light;
receiving reflected infrared light, and generating an electrical signal according to the reflected infrared light;
receiving the electrical signal and determining whether the value of the electrical signal is higher than a standard value; and
if the value of the electrical signal is higher than the standard value, invoking the interface on the touch-screen.

14. The controlling method of claim 13, furthering comprising:
filtering the electrical signal;
receiving the filtered electrical signal and determining whether the value of the filtered electrical signal is higher than the standard value;
if the value of the filtered electrical signal is higher than the standard value, generating a first drive signal; and
activating the interface on the touch-screen according to the first drive signal.

15. The controlling method of claim 14, furthering comprising:
if the value of the filtered electrical signal is lower than the standard value, generating a second drive signal; and
deactivating the interface on the touch-screen according to the second drive signal.

16. The controlling method of claim 13, furthering comprising:
transforming touch operations from the interface into operating instructions; and
executing different functions of the electronic device according to the operating instructions.

17. The controlling method of claim 13, wherein the electrical signal is a selection from current and voltage.

18. An electronic device, comprising:
a touch-screen configured for displaying a interface with various touchable items;
an infrared sensor configured for receiving infrared light originated from an object of a user, and for generating sensing signals indicating an intensity of the received infrared light; and
a control module configured for generating a determining result for determining whether a value of the sensing signals satisfies a predetermined condition, so as to recognize if a distance between the object of the user and the touch-screen is within a predetermined value, the control module further configured for invoking the interface to be displayed on the touch-screen according to the determining result.

19. The electronic device of claim 18, wherein the control module comprises an inducing unit and a processing unit, the inducing unit is configured for transforming touch operations from the interface into operating instructions, the processing unit is further configured for executing different functions of the electronic device according to the operating instructions.

20. The electronic device of claim 18, wherein the control module comprises a processing unit and a driver unit, the processing unit is configured for generating a first drive signal if the value of the sensing signals satisfies the predetermined condition, and further generating a second drive signal if the value of the sensing signals does not satisfy the predetermined condition, the driver unit is configured for enabling the interface to be displayed by the touch-screen according to the first drive signal, or disabling the interface to be displayed by the touch-screen according to the second drive signal.
